(19) United States
(12) Patent Application Publication
(10) Pub. No.: US 2015/0298625 A1
(43) Pub. Date: Oct. 22, 2015

(54) ACTUATOR, MOTOR VEHICLE COMPRISING SUCH ACTUATOR AND METHOD FOR OPERATING AN ACTUATOR

(71) Applicant: AUDI AG, Ingolstadt (DE)

(72) Inventor: Michael KILGER, Abensberg (DE)

(21) Appl. No.: 14/649,617

(22) PCT Filed: Mar. 14, 2013
(86) PCT No.: PCT/EP2013/000784

§ 371 Date: Jun. 4, 2015

(30) Foreign Application Priority Data
Dec. 19, 2012 (DE) 10 2012 024 862.8

(51) Int. Cl. B60R 16/02; H01F 7/18

(52) U.S. Cl. CPC B60R 16/02; H01F 7/1844; H01F 2007/185

(57) ABSTRACT

An actuator (1), which is developed for converting an electronic signal into mechanical motion, with a breakaway function for rectifying a malfunction, such as jamming, wherein the means is provided to supply an increased electric voltage to the actuator (1) if the breakaway function is activated.

The invention relates to an actuator, which is developed for converting an electronic signal into mechanical motion, with a breakaway function for rectifying a malfunction, such as jamming.

The term actuator used in this application, refers generally to a positioner or a positioning element that can preferably be utilized in a motor vehicle to convert an electronic signal into a motion. As a result of moving a component, an adjustment of a movable component part can be realized, in order to perform a specific, desired function. This adjustment can be done by shifting or by rotation, for example. A large number of these type of actuators are utilized in motor vehicles, in order to carry out mechanical adjustment motions on a combustion engine or on component assemblies assigned to it, for example, or on the chassis or on the body.

Actuators mostly have an electromechanical drive, which generates an electromagnetic field that exerts a force onto a movable or adjustable component part, as a result of which the desired motion is initiated. The overall service life and safe operation for actuators that are installed in motor vehicles must be ensured. With increasing service life, malfunctioning such as jamming can occur, however, whereby malfunctioning of a component assembly which requires this adjustment function can consequently occur. Therefore, it is already known to provide a breakaway function for actuators, wherein the force exerted by the actuator or the torque exerted by the actuator is changed temporarily with the objective to overcome the increased friction that exists in the jammed stage and to again restore the normal function.

DE 197 39 827 A1 proposes a method and a device for controlling an operating parameter of a motor vehicle, wherein a positioning element affected by friction and influencing an operating parameter is actuated by a control signal, wherein the control signal is changed until the static friction has been overcome.

DE 198 45 524 A1 proposes an electromagnetic positioner for combustion engines, in which a breakaway function is implemented. The breakaway takes place by changing the pulse duty factor of the control signal.

In a similar manner, DE 103 54 470 A1 quotes a method for controlling a positioning element in which a breakaway function is provided. The control signal is a pulse-width modulated signal. To trigger the breakaway of the positioning element, the pulse duty factor and/or the amplitude of the control signal are changed.

U.S. Pat. No. 5,078,110 A proposes a method and a device to identify and breakaway a blocked actuator. In this context it is proposed that the control signal is increased or decreased within a specific time window in order to allow the desired positioning movement of the actuator.

GB 2 267 581 A proposes to use a pulse-width modulated signal with at least two frequencies with an actuator utilized in a motor vehicle, in order to remediate or prevent jamming.

The various devices and methods known in the prior art to remediate jamming of the activator mostly require costly control controls.

The object of the invention therefore is to indicate an actuator in which the breakaway function can be realized easier and more effectively.

To solve this problem in an actuator of the aforementioned type, a means is provided to supply an increased electric voltage to the activator in the breakaway function is activated.

The invention is based upon the consideration that raising the supply voltage of the actuator temporarily results in increasing the force or the torque exerted, whereby the jamming is slackened. Because of the increased force or the increased torque, the occurring frictional forces which have prevented the actuating adjustment can be overcome in most cases. Increasing the supply voltage provided according to the invention can be implemented comparatively easily. For this purpose, the means of the actuator as taught by the invention preferably has a control unit that is developed for increasing the voltage supplied to the actuator when the breakaway function is activated. Accordingly, in most cases, a control unit that is available anyway can be utilized in order to influence the supply voltage of the actuator as desired.

A development of the invention can provide that the actuator has a position sensor for producing a sensor signal. The position of the actuator or a movable component of the actuator can be detected by means of a position sensor, so that the presence of a malfunction, such as jamming, can be detected, if present.

In this connection, it can also be provided that the control unit is developed for evaluating the sensor signal and to detect a malfunction. The breakaway function can be activated after detecting a malfunction in order to eliminate the malfunction.

In addition, the invention relates to a motor vehicle. The vehicle according to the invention is characterized in that it comprises at least one actuator of the described type. The actuator can for example be arranged on a combustion engine, on a component assembly assigned to the combustion engine, on the chassis or on the body, in order to convert an electronic signal into mechanical motion.

In addition, the invention relates to a method for operating an actuator that converts an electronic signal into a mechanical motion, on which actuator a breakaway function for remediating a malfunction such as jamming is implemented.

The method as taught by the invention is characterized in that the actuator is provided with an increased electric voltage if the breakaway function is activated.

The sub-claims contain further embodiments of the method as taught by the invention.

The invention is subsequently explained by means of an embodiment with reference to the Figures. The drawings are schematic representations, showing:

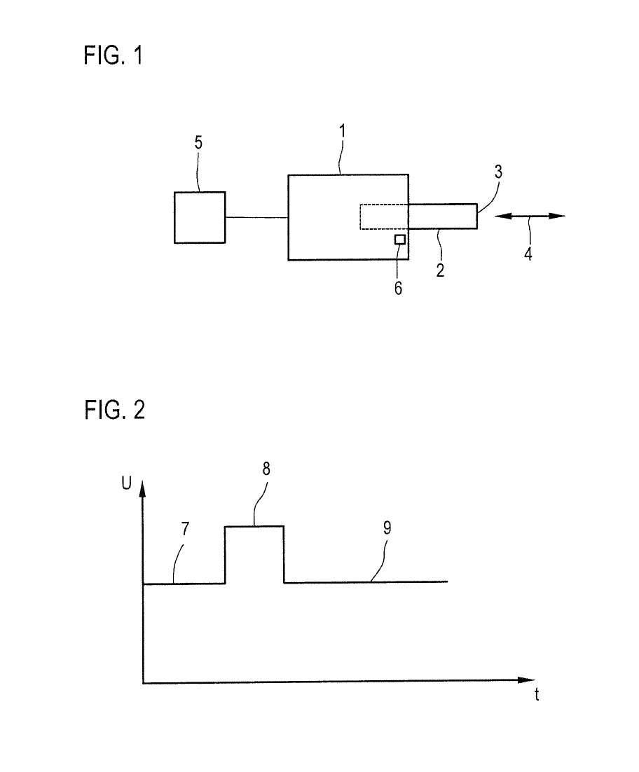

FIG. 1 is an actuator as taught by the invention; and

FIG. 2 shows the time history of the voltage when the breakaway function is activated.

FIG. 1 shows an actuator 1, which is developed for converting an electronic signal into mechanical motion. The actuator 1 has a piston 2, the free end 3 of which protrudes from a housing of the actuator 1. The piston 2 can be moved along the direction indicated by the double arrow 4. The piston 2 movement is electromechanical, as a result of which the piston 2 can be positioned. A further component part can be attached on the free end 3 or the piston 2 can initiate an action by the movement, such as opening or closing a valve or moving or positioning another component part.

The actuator 1 comprises an electromechanical drive, which is not represented in detail in FIG. 1. A control unit 5 regulates the actuator 1 connected with it, in that it controls the supply voltage for the electromechanical drive. A position sensor 6 arranged in the actuator 1 is developed for detecting the position of the piston 2 and for generating a sensor signal. The position sensor 6 sensor signal is analyzed in the control unit 5.

Malfunctioning of the actuator 1, specifically the jamming of the piston, can be detected by the control unit 5 by means of the sensor signal supplied by the position sensor 6. If a malfunction such as jamming occurs, the control unit 5 activates a breakaway function. For this purpose, an increased electric voltage is supplied to the actuator 1 as voltage supply.

FIG. 2 shows the time history of the supply voltage when the breakaway function is activated. FIG. 2 is a diagram, in which the time is entered on the horizontal axis, and the voltage is entered qualitatively on the vertical axis.

During trouble-free operation, the actuator 1 is supplied with a specific supply voltage. This voltage level is indicated by the reference symbol 7 in FIG. 2. The breakaway function is activated when a malfunction occurs. The reference symbol 8 indicates the period of time during which the supply voltage of the actuator 1 is increased by the control unit 5. Because of the increased voltage, the force exerted on the piston 2 increases so that the friction causing the jamming can be overcome, so that the piston 2 can be moved into the desired position. The sensor signal provided by the position sensor 6 can be used to verify proper functioning of the piston 2 movement. Once it has been determined that the piston 2 can be moved free from interference without jamming, as shown in FIG. 2, the supply voltage of the actuator 1 is reduced to a normal value again. The reference symbol 9 denotes the supply voltage level, after the breakaway function has been the activated. Typically, the breakaway function is activated merely briefly, i.e. the increased supply voltage is applied to the actuator for a few seconds, for example.

1. An actuator (1), which is developed for converting an electronic signal into mechanical motion, with a breakaway function for rectifying a malfunction, such as jamming, wherein a means is provided to supply an increased electric voltage to the actuator (1) if the breakaway function is activated,
characterized in that
the actuator (1) comprises a translationally movable piston (2) as well as a position sensor (6) for detecting the position of the piston (2) and for generating a sensor signal.

2. The actuator according to claim 1,
characterized in that
the means comprises a control unit (5), which is developed for increasing the voltage supplied to the actuator (1) when the breakaway function is activated.

3. The actuator according to claim 2,
characterized in that
the control unit (5) is developed for evaluating the sensor signal and for detecting a malfunction.

4. A motor vehicle,
characterized in that
it comprises at least one actuator (1) according to claim 1.

5. A method for operating an actuator that converts an electronic signal into a mechanical motion, on which actuator a breakaway function for remediating a malfunction such as jamming is implemented, wherein an increased electric voltage is supplied to the actuator when the breakaway function is activated,
characterized in that
the actuator comprises a translationally movable piston as well as a position sensor, which detects the position of the piston and generates a sensor signal.

6. The method according to claim 5,
characterized in that
a malfunction such as jamming is determined by means of a control unit.
